(19) United States
(12) Patent Application Publication
(10) Pub. No.: US 2003/0089833 A1
(43) Pub. Date: May 15, 2003

(54) Supporting device for longitudinal post

(76) Inventor: Shih Hao Hsu, Taichung (TW)

Correspondence Address: Shih Hao HSU, P.O. Box 63-99, Taichung, 406, TW

(21) Appl. No.: 09/986,823

(22) Filed: Nov. 13, 2001

(51) Int. Cl. F16M 13/00; H01Q 1/12

(52) U.S. Cl. 248/532

(57) ABSTRACT

A tubular member includes a chamber for receiving posts, and a gasket having a bore formed by a peripheral wall which may be engaged between the tubular member and the post for solidly retaining the post in the erect position. The tubular member has a cone-shaped end for easily engaging into the soil, and a cone-shaped cavity for receiving the posts of different diameters, and an upper peripheral panel for engaging with the soil. The gasket includes a frustum-shaped outer peripheral surface for engaging between the tubular member and posts of different diameters.

### BACKGROUND OF THE INVENTION

1. Field of the Invention

The present invention relates to a supporting device, and more particularly to a supporting device for supporting a longitudinal post or the like in an erect position.

2. Description of the Prior Art

Typical longitudinal posts, such as the longitudinal posts of the flags, or of the parasols or of the sunshades, include a lower end required to be deeply engaged into the soil for supporting the flags, the parasols, or the sunshades in the erect position. Some of the longitudinal posts may include a sharp lower end for easily engaging into the soil. However, the longitudinal post may easily loosen the soil after use, such that the soil may not be used for stably supporting the longitudinal posts in the erect position.

For the other longitudinal posts, such as the longitudinal posts for supporting the coats or clothes, a complicated configuration or frame may be built or constructed for forming a supporting device and for supporting the longitudinal post or the like in the erect position. The longitudinal posts for clothes or for coats may not be easily engaged into or supported on the soil at the erect position.

The present invention has arisen to mitigate and/or obviate the afore-described disadvantages of the conventional supporting device for supporting the longitudinal posts at the erect positions.

### SUMMARY OF THE INVENTION

The primary objective of the present invention is to provide a supporting device for stably supporting a longitudinal post or the like in an erect position.

In accordance with one aspect of the invention, there is provided a supporting device for supporting a longitudinal post in an erect position, and comprising a tubular body including a hollow chamber for receiving the post, and including a first end having a tip for engaging into a soil, and including a second end having an opening formed therein and communicating with the hollow chamber thereof for receiving the post, and a gasket including a bore formed therein for receiving the post, and including a peripheral wall for defining the bore thereof, the peripheral wall of the gasket being provided for engaging between the second end of the tubular body and the post for solidly retaining the post in the erect position.

The first end of the tubular body is cone-shaped for engaging into the soil. The tubular body includes an outer peripheral portion having a reinforcing rib which includes a segment extended outward of the cone-shaped first end of the tubular body for reinforcing the first end of the tubular body.

The segment of the reinforcing rib includes a first end located close to the tubular body and a second end having the tip of the tubular body formed therein, the segment of the reinforcing rib includes a thickness gradually reduced from the first end thereof toward the second end thereof.

The tubular body includes a cone-shaped cavity communicating with the chamber of the tubular body and defined by a cone-shaped inner peripheral surface for engaging with posts of different diameters.

The second end of the tubular body includes a peripheral panel for engaging with the soil. The reinforcing rib includes a segment extended toward the peripheral panel for reinforcing the peripheral panel.

The peripheral panel includes an outer peripheral portion having at least one projection extended downward therefrom for engaging into the soil. The segment may be extended toward the projection for reinforcing the peripheral panel and the projection.

The gasket includes a slot formed in the peripheral wall thereof for allowing the bore of the gasket to receive posts of different diameters.

The gasket includes a frustum-shaped outer peripheral surface for engaging between the tubular body and posts of different diameters.

The opening of the tubular body includes a frustum-shape for engaging with the frustum-shaped outer peripheral surface of the gasket.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a supporting device for supporting a longitudinal post or the like in an erect position in accordance with the present invention, as seen from the upper portion thereof;

FIG. 2 is an exploded view of the supporting device, as seen from the upper portion thereof, in which the supporting base has been cut off for showing the inner structure thereof; and

FIGS. 3 and 4 are cross sectional views illustrating the operation of the supporting device for supporting various kinds of longitudinal posts or the like in the erect position.

### DETAILED DESCRIPTION OF THE PREFERRED EMBODIMENT

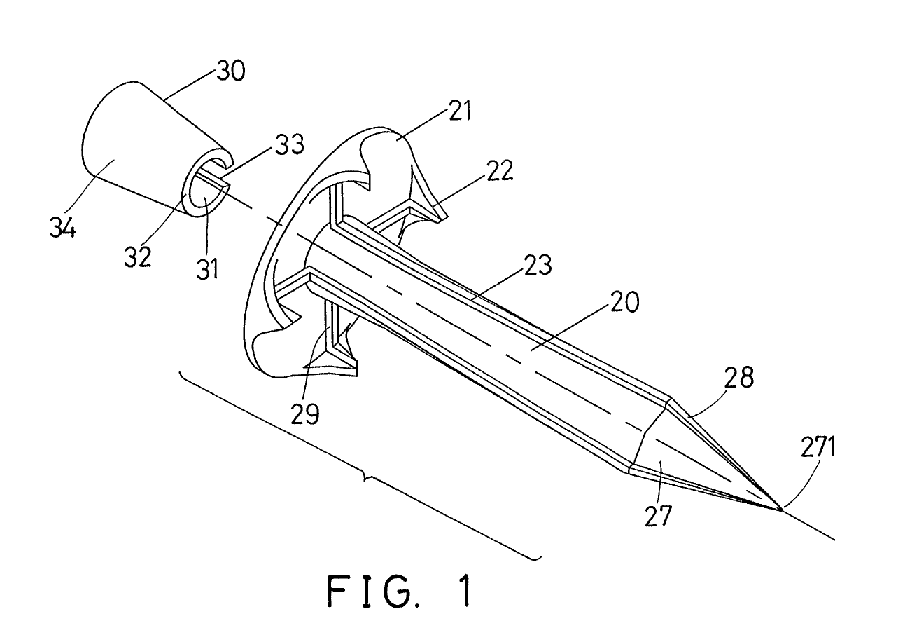

Referring to the drawings, and initially to FIGS. 1-3, a supporting device in accordance with the present invention is provided for supporting a longitudinal post or the like in an erect position and comprises a tubular body 20 including a sharp end or a sharp or cone-shaped end member 27 formed and provided on the lower portion thereof for easily engaging into the soil or the like, and including a hollow longitudinal chamber 24 formed therein for receiving the post 1 or the like. The tubular body 20 includes an upper portion having a peripheral panel 21 extended laterally and radially outward therefrom. The peripheral panel 21 includes one or more projections 22 extended or dependent downward from the outer peripheral portion thereof for engaging into the soil or the like and for further solidly positioning the panel 21 and the tubular body 20 in the soil or the like and for preventing the tubular body 20 from being tilted relative to the soil or the like.

The tubular body 20 includes one or more reinforcing ribs 23 formed on the outer peripheral portion thereof and extended along the longitudinal direction of the tubular body 20 for reinforcing the tubular body 20. The reinforcing ribs 23 include one end segment 29 extended toward the bottom surface of the peripheral panel 21 and/or toward the projections 22 for reinforcing the panel 21 and the projections 22, and include the other segment 28 extended on the outer peripheral portion of the end member 27 of the tubular body 20, for reinforcing the end member 27 of the tubular body 20. The other segments 28 of the reinforcing ribs 23 preferably include a width and/or a thickness gradually reduced from the end close to the tubular body 20 toward the other end close to the tip 271 of the end member 27, best shown in FIG. 1.

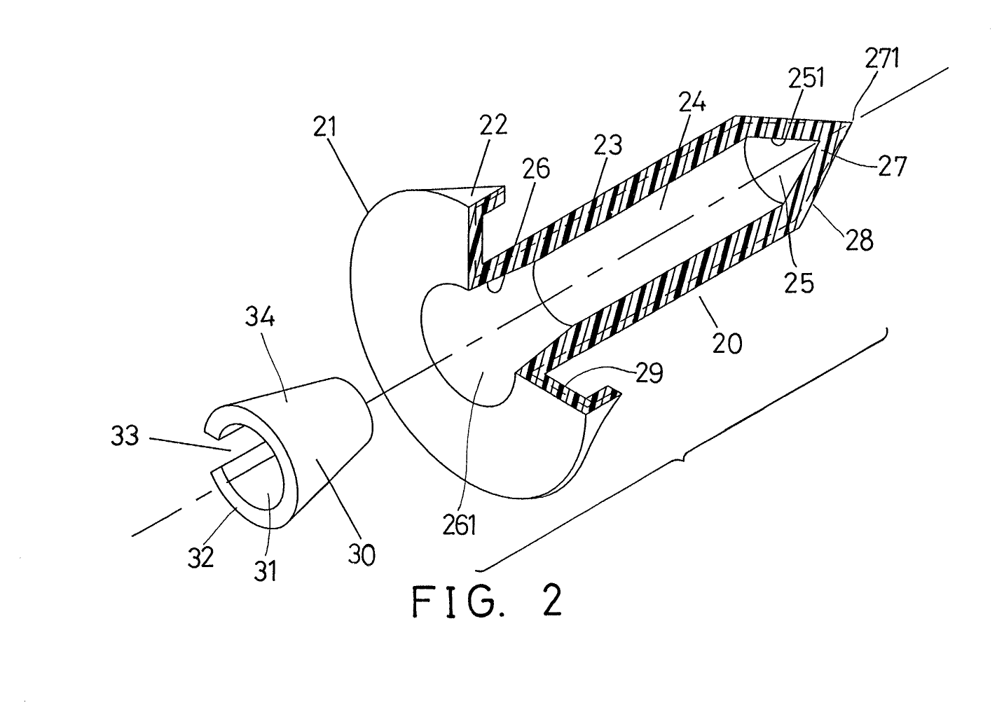

As best shown in FIGS. 2-4, the tubular body 20 includes a cone-shaped cavity 25 formed in the lower end thereof and/or formed in the cone-shaped end member 27 and communicating with the hollow chamber 24 thereof, and formed or defined by a cone-shaped inner peripheral surface 251, such that the posts 1 of different widths or diameters may be solidly engaged with the cone-shaped inner peripheral surface 251 of the tubular body 20 and may be prevented from moving relative to the tubular body 20. The tubular body 20 further includes a frustum-shaped opening 26 formed in the upper portion thereof and communicating with the hollow chamber 24 thereof, and formed or defined by a frustum-shaped or inclined inner peripheral surface 261.

One or more gaskets 30 each includes a bore 31 formed therein for receiving the longitudinal posts 1 of different diameters or widths or the like, and each includes an outer peripheral wall 32 having a longitudinal slot 33 formed therein for allowing the gaskets 30 to be expanded and for allowing the posts 1 of different diameters or widths to be engaged into the bores 31 of the gaskets 30. The gaskets 30 include a frustum-shaped outer peripheral surface 34 having an inclination corresponding to that of the inner peripheral surface 261 of the tubular body 20 and for allowing the gaskets 30 to be solidly engaged between the tubular body 20 and the posts 1 of different diameters or widths or the like.

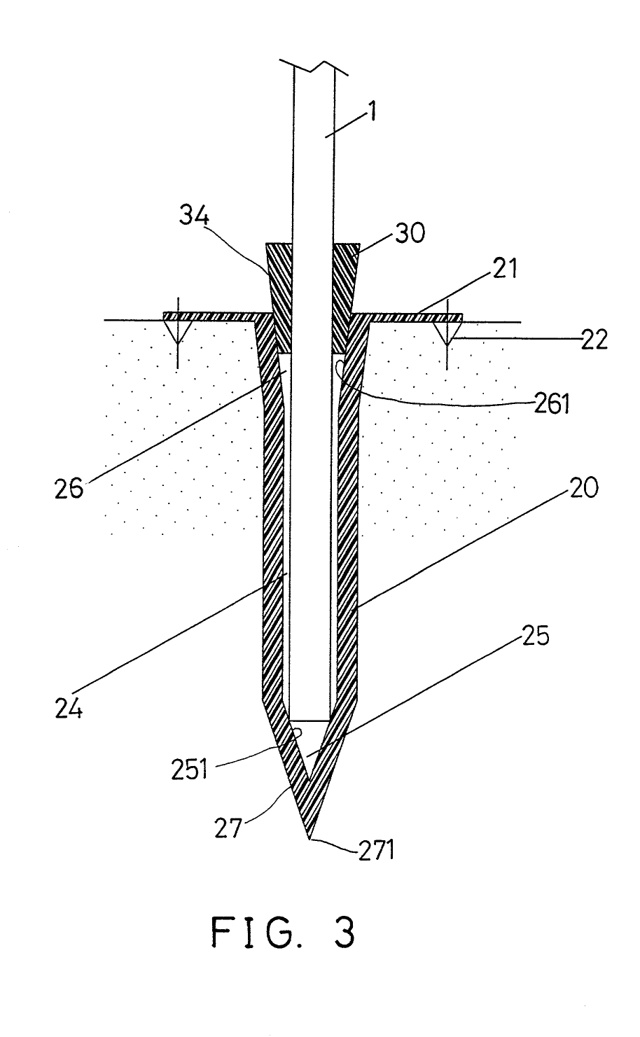

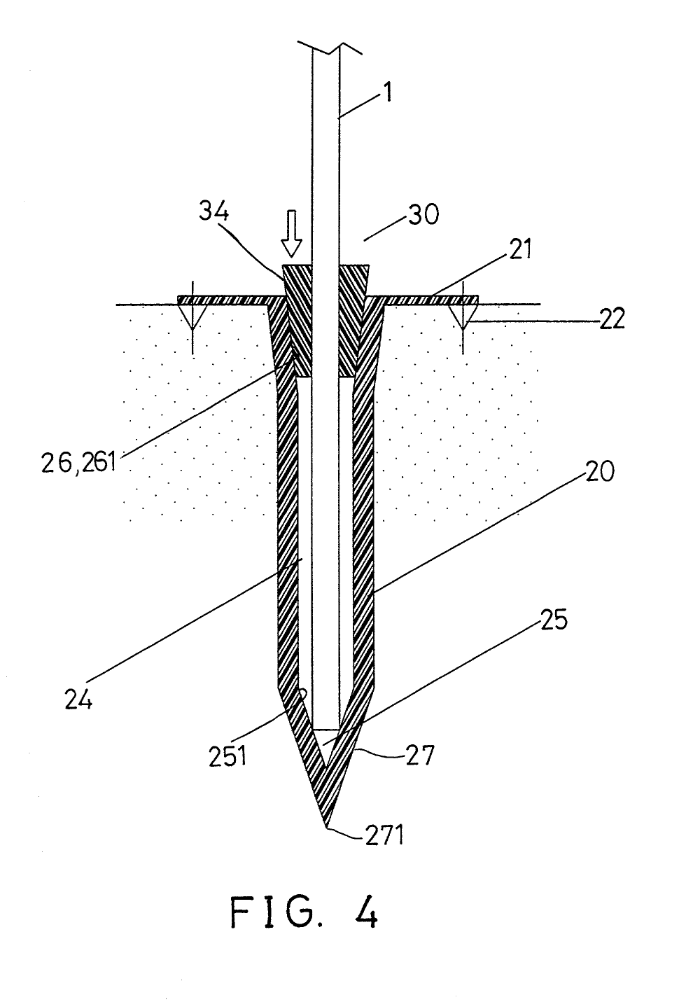

For example, as shown in FIG. 3, when the diameter of post 1 has a greater diameter than that of the other posts 1 as shown in FIG. 4, the gasket 30 may be slightly extended outward of the tubular body 20 for allowing the gasket 30 to be solidly engaged between the tubular body 20 and the post 1 of greater diameters or widths or the like. As shown in FIG. 4, the gasket 30 may be further engaged into the frustum-shaped opening 26 of the tubular body 20 when the posts 1 include smaller diameters, such that the gasket 30 may also be solidly engaged between the tubular body 20 and the post 1 of smaller diameters or widths or the like.

Accordingly, the supporting device in accordance with the present invention may be used for easily and stably supporting the longitudinal posts or the like in the erect position.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A supporting device for supporting a longitudinal post in an erect position, said supporting device comprising:
a tubular body including a hollow chamber formed therein for receiving the post, and including a first end having a tip for engaging into a soil, and including a second end having an opening formed therein and communicating with said hollow chamber thereof for receiving the post, and
a gasket including a bore formed therein for receiving the post, and including a peripheral wall for defining said bore thereof, said peripheral wall of said gasket being provided for engaging between said second end of said tubular body and the post for solidly retaining said post in the erect position.

2. The supporting device according to claim 1, wherein said first end of said tubular body is cone-shaped for engaging into the soil.

3. The supporting device according to claim 2, wherein said tubular body includes an outer peripheral portion having a reinforcing rib extended thereon, said reinforcing rib includes a segment extended outward of said cone-shaped first end of said tubular body for reinforcing said first end of said tubular body.

4. The supporting device according to claim 3, wherein said segment of said reinforcing rib includes a first end located close to said tubular body and a second end having said tip of said tubular body formed therein, said segment of said reinforcing rib includes a thickness gradually reduced from said first end thereof toward said second end thereof.

5. The supporting device according to claim 1, wherein said first end of said tubular body includes a cone-shaped cavity formed therein and communicating with said hollow chamber of said tubular body and defined by a cone-shaped inner peripheral surface for engaging with posts of different diameters.

6. The supporting device according to claim 1, wherein said second end of said tubular body includes a peripheral panel extended radially outward therefrom for engaging with the soil.

7. The supporting device according to claim 6, wherein said tubular body includes an outer peripheral portion having a reinforcing rib extended thereon, said reinforcing rib includes a segment extended toward said peripheral panel for reinforcing said peripheral panel.

8. The supporting device according to claim 6, wherein said peripheral panel includes an outer peripheral portion having at least one projection extended downward therefrom for engaging into the soil.

9. The supporting device according to claim 8, wherein said tubular body includes an outer peripheral portion having a reinforcing rib extended thereon, said reinforcing rib includes a segment extended toward said peripheral panel and said at least one projection for reinforcing said peripheral panel and said at least one projection.

10. The supporting device according to claim 1, wherein said gasket includes a slot formed in said peripheral wall thereof for allowing said bore of said gasket to receive posts of different diameters.

11. The supporting device according to claim 1, wherein said gasket includes a frustum-shaped outer peripheral surface for engaging between said tubular body and posts of different diameters.

12. The supporting device according to claim 11, wherein said opening of said tubular body includes a frustum-shape for engaging with said frustum-shaped outer peripheral surface of said gasket.
